(19) United States
(12) Patent Application Publication
(10) Pub. No.: US 2007/0223823 A1
(43) Pub. Date: Sep. 27, 2007

(54) Method, apparatus, system and computer program product for providing compression of image files

(75) Inventors: Asad Islam, Richardson, TX (US); Fehmi Chebil, Irving, TX (US); Ossi Kalevo, Toijala (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/385,594

(22) Filed: Mar. 21, 2006

(51) Int. Cl. G06K 9/36

(52) U.S. Cl. 382/232

(57) ABSTRACT

A method of providing compression of image files includes modifying an input image by eliminating a predetermined number of bits from lower bit planes of the input image, and encoding the modified image. Elimination of the predetermined number of bits of the input image may be performed by a bit plane shift of the predetermined number of bits. The image files may then be decompressed by decoding an encoded image, and reconstructing the decoded image by replacing the eliminated predetermined number of bits with replacement bits.

### FIELD OF THE INVENTION

Embodiments of the present invention relate generally to mobile terminal technology and, more particularly, relate to a method, apparatus, system and computer program product for providing compression of data files, and particularly image data files.

### BACKGROUND OF THE INVENTION

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One area in which there is a demand to increase ease of information transfer relates to image processing services for images captured by a mobile terminal. The image processing services may be provided from a network server or other network device, from the mobile terminal such as, for example, a mobile telephone, a mobile television, a mobile gaming system, etc, or even from a combination of the mobile terminal and the network device. The image processing services may include transmission, storage, processing, etc., of image files. For example, images captured by the mobile terminal may be stored in a memory of the mobile terminal, or communicated from the mobile terminal to a network device, such as a photo printer in communication with a wireless network.

In current applications, a user of a mobile terminal who wishes to wirelessly communicate images captured by the mobile terminal may experience relatively long delays in transmitting the images to the network device. The long delays result due to the relatively long transmission times required to transmit image files of the size typically captured by imaging devices on modern mobile terminals. This is true even for image files that have been compressed, for example, by JPEG compression, which is well known in the art and commonly employed in current mobile terminals. For example, a high resolution and high quality image captured by a modern mobile terminal may be about 2 mega pixels at a resolution of 1600×1200 pixels. Even after image compression, such as JPEG compression, a typical compressed image file size may be between 200 and 500 kilobytes. A typical natural image may have a compressed image file size of about 350 kilobytes. At a common existing data rate of 20 to 40 kilobits per second, such as GPRS, it may take up to 1 or 2 minutes to transmit one 350 kilobyte image file.

Additionally, even assuming the user does not transmit the image file wirelessly, but instead, chooses to store the image file in a memory device of the mobile terminal, the size of the image file presents problems. For example, a 64 megabyte memory card used in connection with the mobile terminal may hold about 200 image files of about 350 kilobytes if the entire memory is devoted to such images.

Given the above described problems, it may be advantageous to compress images, or otherwise reduce image file size beyond the standard compression methods currently employed. However, attempts to further reduce image file size often lead to a loss in image data and a subsequent reduction in image quality. Thus, there is a need for a means to reduce image file size while minimizing any degradation that is visually perceptible to a viewer of the image.

### BRIEF SUMMARY OF THE INVENTION

A method, apparatus, system and computer program product is therefore provided that compresses image files with visually imperceptible degradation in image quality. Thus, storage space and transmission times for high resolution image files may be reduced without compromising image quality. Accordingly, efficiency may be increased for storage and transmission operations related to image files.

In one exemplary embodiment, methods and computer program products for providing compression and decompression of image files are provided. The methods and computer program products include modifying an input image by eliminating a predetermined number of bits from lower bit planes of the input image, and encoding the modified image. Elimination of the predetermined number of bits of the input image may be performed by a bit plane shift of the predetermined number of bits. The image files may then be decompressed by decoding an encoded image, and reconstructing the decoded image by replacing the eliminated predetermined number of bits with replacement bits.

In another exemplary embodiment, a device for providing compression of image files is provided. The device includes a decoder and a bit plane shift image reconstructor. The decoder is capable of decoding the encoded image. The encoded image is modified by eliminating a predetermined number of bits from lower bit planes of an input image. The bit plane shift image reconstructor is capable of reconstructing the decoded image by replacing the eliminated predetermined number of bits with replacement bits.

In another exemplary embodiment, mobile terminals for providing compression and/or decompression of image files are provided. A mobile terminal for providing compression of image files includes a bit plane shift image modifier and an encoder. The bit plane shift image modifier is capable of modifying an input image by eliminating a predetermined number of bits from lower bit planes of the input image. The encoder is capable of encoding the modified image. A mobile terminal for providing decompression of image files includes a bit plane shift image reconstructor and a decoder. The decoder is capable of decoding the encoded image. The bit plane shift image reconstructor is capable of reconstructing the decoded image by replacing the eliminated predetermined number of bits with replacement bits.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 illustrates a block diagram showing an encoding module and a decoding module according to an exemplary embodiment of the present invention; and

FIG. 4 is a block diagram according to an exemplary method of compressing image files according to an exemplary embodiment of the present invention.

### DETAILED DESCRIPTION OF THE INVENTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

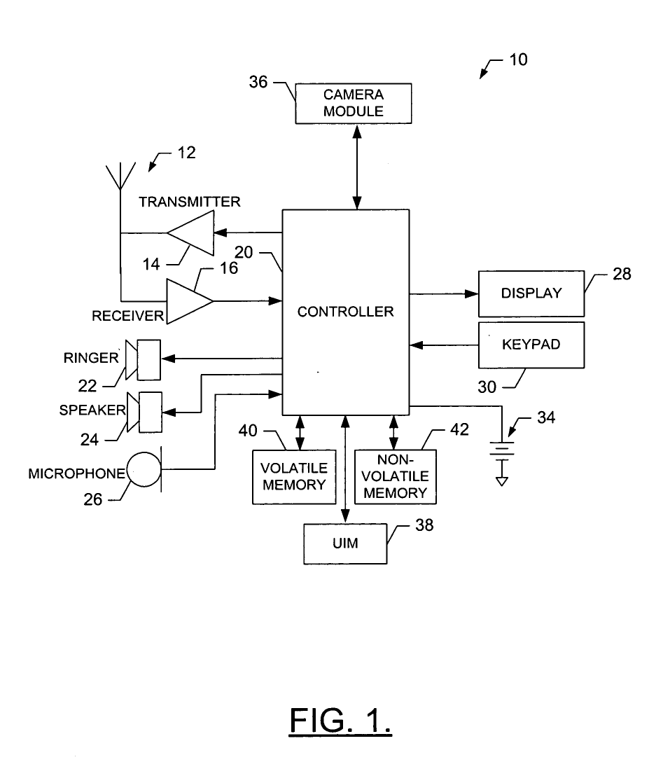

FIG. 1 illustrates a block diagram of a mobile terminal 10 that would benefit from the present invention. It should be understood, however, that a mobile telephone as illustrated and hereinafter described is merely illustrative of one type of mobile terminal that would benefit from the present invention and, therefore, should not be taken to limit the scope of the present invention. While several embodiments of the mobile terminal 10 are illustrated and will be hereinafter described for purposes of example, other types of mobile terminals, such as portable digital assistants (PDAs), pagers, mobile televisions, laptop computers and other types of voice and text communications systems, can readily employ the present invention.

In addition, while several embodiments of the method of the present invention are performed or used by a mobile terminal 10, the method may be employed by other than a mobile terminal. Moreover, the system and method of the present invention will be primarily described in conjunction with mobile communications applications. It should be understood, however, that the system and method of the present invention can be utilized in conjunction with a variety of other applications, both in the mobile communications industries and outside of the mobile communications industries.

The mobile terminal 10 includes an antenna 12 in operable communication with a transmitter 14 and a receiver 16. The mobile terminal 10 further includes a controller 20 or other processing element that provides signals to and receives signals from the transmitter 14 and receiver 16, respectively. The signals include signaling information in accordance with the air interface standard of the applicable cellular system, and also user speech and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second and/or third-generation communication protocols or the like. For example, the mobile terminal 10 may be capable of operating in accordance with second-generation (2G) wireless communication protocols IS-136 (TDMA), GSM, and IS-95 (CDMA) or third-generation wireless communication protocol Wideband Code Division Multiple Access (WCDMA).

It is understood that the controller 20 includes circuitry required for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content, according to a Wireless Application Protocol (WAP), for example.

The mobile terminal 10 also comprises a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other keys used for operating the mobile terminal 10. Alternatively, the keypad 30 may include a conventional QWERTY keypad. The mobile terminal 10 further includes a battery 34, such as a vibrating battery pack, for powering various circuits that are required to operate the mobile terminal 10, as well as optionally providing mechanical vibration as a detectable output.

In an exemplary embodiment, the mobile terminal 10 includes a camera module 36 in communication with the controller 20. The camera module 36 may be any means for capturing an image for storage, display or transmission. For example, the camera module 36 may include a digital camera capable of forming a digital image file from a captured image. As such, the camera module 36 includes all hardware, such as a lens or other optical device, and software necessary for creating a digital image file from a captured image. Alternatively, the camera module 36 may include only the hardware needed to view an image, while a memory device of the mobile terminal 10 stores instructions for execution by the controller 20 in the form of software necessary to create a digital image file from a captured image.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10.

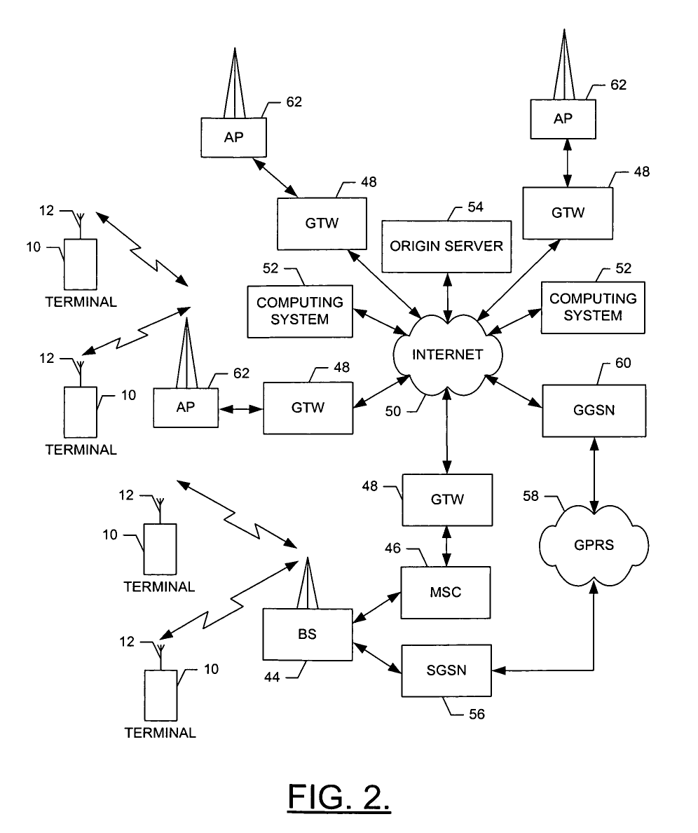

Referring now to FIG. 2, an illustration of one type of system that would benefit from the present invention is provided. The system includes a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and the present invention is not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a GTW 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52 (two shown in FIG. 2), origin server 54 (one shown in FIG. 2) or the like, as described below.

The BS 44 can also be coupled to a signaling GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a GTW GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, etc.) to the Internet 50, the mobile terminals 10 may communicate with the other devices and with one another, such as according to the Hypertext Transfer Protocol (HTTP), to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) can be capable of supporting communication in accordance with any one or more of a number of first-generation (1G), second-generation (2G), 2.5G, third-generation (3G) and/or future mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), Bluetooth (BT), infrared (IrDA) or any of a number of different wireless networking techniques, including wireless LAN (WLAN) techniques such as IEEE 802.11 (e.g., 802.11a, 802.11b, 802.11g, 802.11n, etc.), WiMAX techniques such as IEEE 802.16, and/or ultra wideband (UWB) techniques such as IEEE 802.15 or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 can communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of the present invention.

Although not shown in FIG. 2, in addition to or in lieu of coupling the mobile terminal 10 to computing systems 52 across the Internet 50, the mobile terminal 10 and computing system 52 may be coupled to one another and communicate in accordance with, for example, RF, BT, IrDA or any of a number of different wireline or wireless communication techniques, including LAN, WLAN, WiMAX and/or UWB techniques. One or more of the computing systems 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including USB, LAN, WLAN, WiMAX and/or UWB techniques.

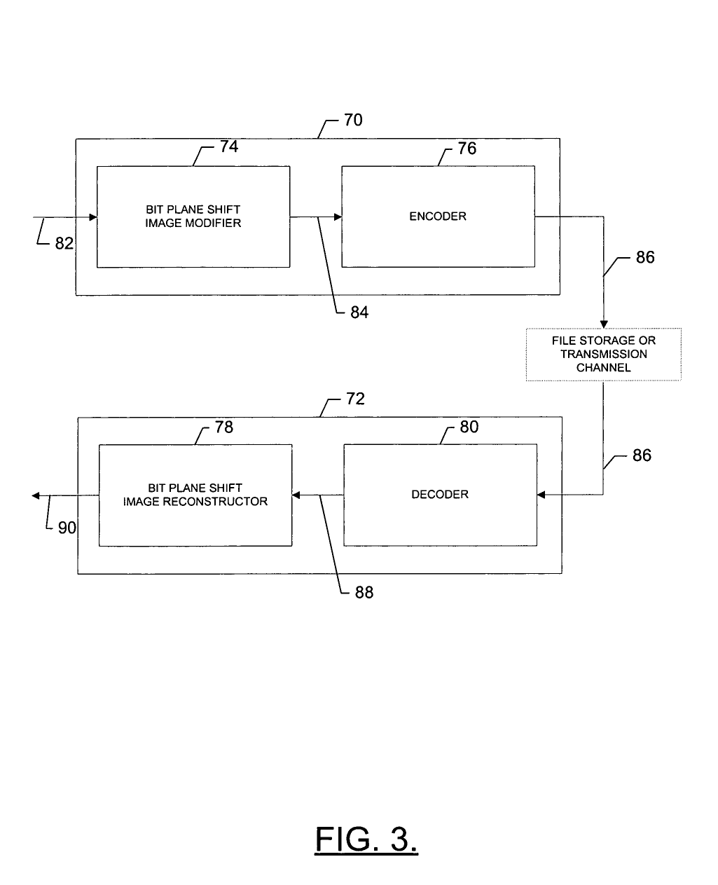

An exemplary embodiment of the invention will now be described with reference to FIG. 3, in which certain elements of a system for reducing image file sizes with visual degradation of image quality that is relatively imperceptible are displayed. The system of FIG. 3 may be employed, for example, on the mobile terminal 10 of FIG. 1 and the computing system 52 or the origin server 54 of FIG. 2. However, it should be noted that the system of FIG. 3, may also be employed on a variety of other devices, both mobile and fixed, and therefore, the present invention should not be limited to application on devices such as the mobile terminal 10 of FIG. 1. It should also be noted, however, that while FIG. 3 illustrates one example of a configuration of a system for reducing image file sizes with visually imperceptible degradation in image quality, numerous other configurations may also be used to implement the present invention. Furthermore, although FIG. 3 is described in the context of transmission of image files from a mobile terminal to a network device, the present invention need not necessarily be practiced in the context of mobile terminals, but also applies more generally to compression of image file sizes with visually imperceptible degradation in image quality.

Referring now to FIG. 3, a system for reducing image file sizes with visually imperceptible degradation in image quality is provided. The system includes an encoding module 70 and a decoding module 72. The encoding module 70 includes a bit plane shift image modifier 74 and an encoder 76. The encoding module 70 may be any means or device embodied in hardware, software or a combination of hardware and software that is capable of both bit plane modification and encoding operations as described below. In an exemplary embodiment, the encoding module 70 is embodied in software as instructions that are stored on a memory of the mobile terminal 10 and executed by the controller 20. The decoding module 70 includes a bit plane shift image reconstructor 78 and a decoder 80. The decoding module 72 may be any device or means embodied in either hardware, software, or a combination of hardware and software that is capable of both decoding and bit plane reconstruction operations as described below. In an exemplary embodiment, the encoding module 70 is embodied in software as instructions that are stored on a memory of the mobile terminal 10 and executed by the controller 20, and the decoding module 72 is embodied in software as instructions that are stored on a memory of a network device, such as, for example, the computing system 52 or the origin server 54 of FIG. 2. Alternatively, the decoding module 72 may be embodied in software as instructions that are stored on a memory of the mobile terminal 10, or another mobile terminal.

A digital image is composed of a plurality of pixels, in which each of the pixels is represented by a certain number of bits. For a typical greyscale natural image, eight bits (or one byte) are used to represent each pixel. A color image has three color planes such as red, green and blue. Each of the three color planes is analogous to a greyscale image. Thus, each pixel of a color image is typically represented by twenty-four bits (or three bytes). If one considers an exemplary 8-bit per pixel image, the image may be thought of as including 8 bit-planes of pixels with each bit-plane having a pixel value of a binary 0 or 1. Accordingly, the 8 bit-planes may describe, for example, a greyscale value of 130 which is represented as 10000010 in binary. The information carried in each of the 8-bits of the greyscale value of 130 has a different weight. The most significant bit (MSB) carries the most weight (a maximum of 128 in this example), while the least significant bit (LSB) carries the least weight (a maximum of 1 in this example). Each bit-plane may then be labeled for clarity, such that the LSB is bit-plane 0, the next more significant bit is bit-plane 1, and so on to the MSB which is bit-plane 7. The MSB is the bit farthest to the left (1 in this example), while the LSB is the bit farthest to the right (0 in this example). Each bit descending from the MSB to the LSB carries one-half the weight of the preceding bit. Accordingly, the weight of the LSB and those bits near the LSB (lower bit planes) may be considered to be of relatively little weight when compared to the weight of the MSB and those bits near the MSB (higher bit planes). In other words, a majority of image information of a greyscale image is provided by the higher bit planes, while a minority of the image information is provided by the lower bit planes.

It should be noted, however, that although the present invention discusses an exemplary embodiment involving an 8 bit per pixel image for greyscale and 24 bit per pixel for color image, other bit depths are also possible, such as, for example, 12, 16, 32, etc. bit per pixel color images. Accordingly, the present invention should not be limited to any particular bit depth.

Since the higher bit planes carry relatively larger amounts of information (or most of the “energy” in the image), the lower bit planes only add tiny details to the bulk of the image information carried in the higher bit planes. As one moves down to the lower bit planes, the “energy” in each bit plane decreases, and so does the correlation between information carrying pixels. This continues down to the lowest bit plane, which can often be considered to behave almost like random noise. In other words, although the lower bit planes provide information that gives minor details regarding an image, these minor details have less visual impact on the human visual system (HVS) than the information provided by higher bit planes. Often, the minor details carried in the lowest bit planes are imperceptible to the HVS. On the other hand, since the lower bit planes have much less spatial correlation among pixels, it is very difficult to achieve good compression for such bit planes. This is unlike the spatially highly correlated higher bit planes, for which it is easier to achieve good compression ratios. As such, the compressed image data corresponding to the lower bit planes comprises a major portion of the overall compressed image data, usually more than the compressed image data corresponding to the higher bit planes. Accordingly, in order to significantly reduce image file size to thereby reduce image storage space requirements and transmission times, the lower bit planes may be removed without compromising image quality as described below.

The bit plane shift image modifier 74 may be any means or device embodied in hardware, software or a combination of hardware and software that is capable of shifting bit-plane data by k number of bits. In an exemplary embodiment, the bit plane shift image modifier 74 is embodied in software as instructions stored in a memory of the mobile terminal 10 and executed by the controller 20. The instructions include code portions that execute a bit-plane shifting process. The bit-plane shifting process may be achieved, for example, by the operation: image[i][j]=image[i][j]>>=k (Equation 1), in which image[i][j], with spatial pixel position (i,j), is an input image 82 and ‘>>=k’ indicates a right shift operation which shifts each pixel of the input image 82 to the right by k number of bits. Thus, for example, if the greyscale value of 130 (10000010) is right shifted by 2 bits (k=2), a modified value 84 of 32 (00100000) results. Note that right shifting bits by 2 eliminates the two lease significant bits and introduces zero bits in the newly created two most significant bit positions. In other words, the 1 and 0 values of original bit planes 1 and 0, respectively, are eliminated and may be referred to as “missing bits”. The “missing bits” have been eliminated by the right shift and each of the remaining pit planes has also shifted right (i.e., former bit plane 7 is now bit plane 5 and bit planes 6 and 7 are now populated by 0). Thus, a range of values that a pixel can have is reduced from 2⁸−1=255 to 2^{8-k}−1, where 0≦k<8. Accordingly, a greyscale image having only 6 bits of information may be encoded and stored or transmitted, which reduces storage space requirements or transmission times. It should be noted that although an 8-bit exemplary pixel is described above, the present invention may be implemented with data having any number of bits.

As described above, a captured image may be provided as the input image 82 to the bit plane shift image modifier 74. The bit plane shift image modifier 74 performs a bit plane shift on the input image 82 to produce the modified value 84 by eliminating a predetermined number of least significant bits k from the input image 82. The modified value 84 is then input into the encoder 76. The encoder 76 may be any encoding device or means known in the art capable of compressing image data. The encoder 76 may be, for example, a JPEG encoder. Accordingly, the encoder 76 produces a compressed image 86 which may be stored in a memory of the mobile terminal 10 or transmitted to a network device or another mobile terminal via any transmission or communication channel, including wireless communication channels.

If the compressed image 86 is transmitted via a transmission channel to the decoding module 72, either after storage or without storage, the compressed image 86 may be decompressed at the decoder 80 to produce a decompressed image 88. The decoder 80 may be any decoding device or means known in the art capable of decompressing image data, which is compatible with the encoder 76. In an exemplary embodiment, the decoder 80 is a JPEG decoder. The decompressed image 88 is substantially identical to the modified value 84, barring conventional compression losses. Accordingly, continuing the example above, one particular pixel of the decompressed image 88 has a greyscale value of binary 32 or 00100000.

The bit plane shift image reconstructor 78 operates to recover image data having relatively minimally reduced image quality. The bit plane shift image reconstructor 78 provides a bit plane shift that is substantially opposite to that of the bit plane shift image modifier 74. Thus, for example, if the bit plane shift image modifier 74 performs the operation of Equation 1, then the bit plane shift image reconstructor 78 performs the operation: image[i][j]′=image[i][j]′<<=k (Equation 2), in which image[i][j]′, with spatial pixel position (i,j), represents the decompressed image 88 and <<=k represents a left shift operation that shifts each pixel of the decompressed image 88 to the left by k number of bits. Continuing the example above, if k=2, then the bit plane shift image modifier 74 performs a right shift by two bits and the bit plane shift image reconstructor 78 performs a left shift by two bits. The left shift operation places the MSB of the input image 82 (which was shifted to bit plane 5 in the example above) at the bit plane 7 position. The eliminated originally least significant bits are replaced with newly created least significant replacement bits having a value of 0. Thus, the particular pixel of the decompressed image 88 having a greyscale value of binary 32 or 00100000 is left shifted by the bit plane shift image reconstructor 78 to produce an output image 90 having a greyscale value of binary 128 or 10000000. The greyscale value of binary 128 of the output image 90 is substantially similar to the original greyscale value of binary 130 of the input image 82. In general, differences between the input image 82 and the output image 90 may not be perceptible to the human visual system, and accordingly, quality degradation is minimized while also reducing transmission times and required storage space.

Although, differences between the input image 82 and the output image 90 may not be perceptible to the human visual system following reconstruction at the bit plane shift image reconstructor 78, it may be possible to further reduce any noticeable quality degradation by estimating a value for the replacement bits during reconstruction at the bit plane shift image reconstructor 78. This process is similar to a scalar de-quantization of the reconstructed pixel. In an exemplary embodiment, the bit plane shift image reconstructor 78 may include an additional operation which de-quantizes the replacement bits to an optimum estimated value. For example, continuing with the example above, when the greyscale value of 130 (binary 10000010) is modified in the bit plane shift image modifier 74, the 1 and 0 bit-planes become “missing bits”, which upon reconstruction at the bit plane shift image reconstructor 78 will each be replaced with a 0 value. The “missing bits” have a maximum binary value of 3 (i.e., 11) and a minimum binary value of 0 (i.e., 00). Accordingly, an optimal estimated value for replacing the “missing bits” (i.e., the replacement bits) upon reconstruction would not be 0, which represents an extreme (namely the low boundary of possible values), rather the optimal estimated value would be a midpoint or average value of the maximum and minimum possible values, namely either 1 (binary 01) or 2 (binary 10).

In order to select the optimal estimated value for the replacement bits, the bit plane shift image reconstructor 78 may perform the operation: image[i][j]″=image[i][j]″|=c (Equation 3), in which ‘|=c’ represents a bitwise “or” operation, and image[i][j]″ represents a reconstructed image without optimal estimated value replacement bits. In an exemplary embodiment, c=2^{k-1} (Equation 4). In other words, continuing with the example above, a bitwise “or” operation is performed between binary 128 (10000000) and binary 2 (00000010) to produce binary 130 (10000010). Accordingly, in the present example, the input image 82 having the original greyscale value of binary 130 is bit plane shifted, compressed, decompressed and reconstructed to reduce image file size for better image file storage or transmission performance, while reconstruction of the output image 90 results in a greyscale value of binary 130, thereby minimizing any perceptible degradation in image quality. It should be noted that although the example above illustrated a case where reconstruction produced an output image having an identical greyscale value to that of the input image 82, such a result is coincidental and not a requirement or expectation of the present invention.

It should be noted that, Equation 4 is only one embodiment of the pixel reconstruction method. In general, any optimal de-quantization method could be invoked to reconstruct the pixel and the present invention will work with any such reconstruction method. For example, instead of replacing the missing bits with optimal estimated value replacement bits, the replacement bits could be given random values. In an exemplary embodiment, a random sequence may be stored in a memory of the mobile terminal 10 and employed to generate random values for the replacement bits. Care should be taken to ensure the random sequence is not a multiple of the image parameter (e.g., image line or macroblock), to ensure that no structural pattern is created in the reconstructed image. Additionally or alternatively, a dithering algorithm may be used to generate values for the replacement bits. Accordingly, contouring effect may be reduced in the reconstructed image.

As shown in FIG. 3, an image that is bit shifted prior to compression or encoding, must also be bit shifted following decompression or decoding in order to retain the desired image quality. Accordingly, since recovery of an image that has been compressed in accordance with the present invention requires a different processing technique than standard recovery methods, if a device or means capable of processing both images compressed by conventional or other means and images compressed by the processed described above, it may be advantageous to enable a processing device or means to identify images requiring different processing techniques. Thus, according to an exemplary embodiment of the present invention, a marker may be inserted in an image file during encoding, which identifies to the decoder that the image file has been encoded according to the present invention. In other words, the marker will identify that the image file requires an appropriate bit shift operation in addition to the normal decoding process. The marker may be any value or attribute that can be written into the image file which is detectable by decoders and which indicates to the decoders that the image file has been encoded as described above. In an exemplary embodiment in which a JPEG image file is created during the encoding process, an EXIF tag may be inserted into the JPEG image file as the marker. The EXIF tag may include information about how many bit planes have been shifted (i.e. the value of k parameter). For example, if there is no marker or a value of the marker is 0, then no bit plane shifting has been performed, but if there is a marker then a value of the marker can tell how many bits have been shifted. Thus, a system according to this exemplary embodiment may be more flexible since bit plane shifts (i.e. the value of k parameter) need not to be fixed. The EXIF tag is detectable by JPEG decoders and thus, the JPEG decoders will identify the JPEG image file as having been modified according to the present invention. Accordingly, if the JPEG image file having the EXIF tag is transmitted to a decoder outside of a closed system, the decoder will “know” that the JPEG image file requires an appropriate bit shift operation during the decoding process. As a result, decoders may be enabled to selectively process both conventional images and images which have been bit shifted as described above. Thus, both conventional images and images compressed according to the present invention can be stored on and/or processed by the same device.

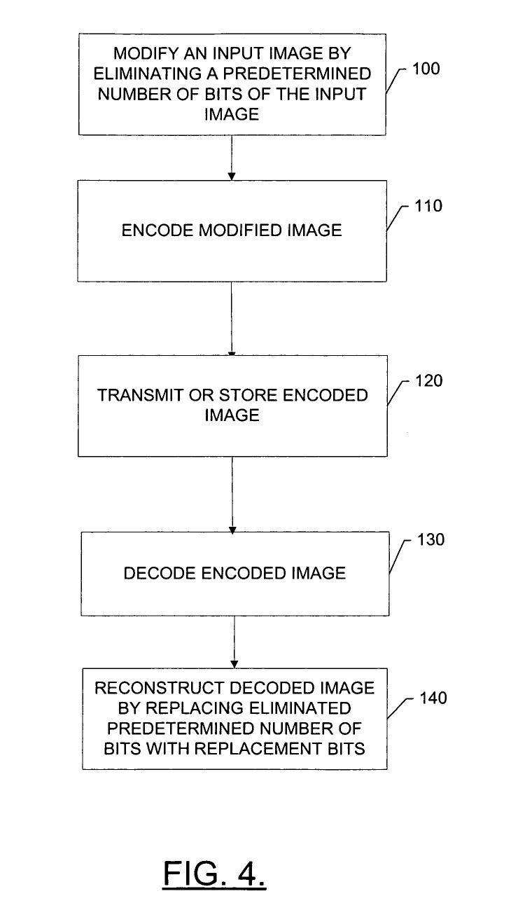

FIG. 4 is a flowchart of a system, method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal and executed by a built-in processor in the mobile terminal. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one embodiment of a method for providing compression of image files includes modifying an input image by eliminating a predetermined number of bits at operation 100. Operation 100 may include providing a bit plane shift to eliminate the predetermined number of bits in a lower bit plane. At operation 110, the modified image is encoded. At operation 120, the encoded image is either stored or transmitted. The encoded image is then decoded at operation 130. At operation 140, the decoded image is reconstructed and the eliminated bits are replaced with replacement bits. Operation 140 may include providing a bit plane shift to reconstruct the decoded image and produce an output image. Optionally, operation 140 may include replacing the eliminated bits with the replacement bits having an optimal value selected substantially as an average of maximum and minimum possible values of the eliminated bits. It should be noted that operations 100, 110, 130 and 140 may all be performed at the mobile terminal 10. Alternatively, operations 100 and 110 may be performed at the mobile terminal 10, while operations 130 and 140 are performed at a network device or another mobile terminal. Furthermore, other entities may perform the operations described above.

The above described functions may be carried out in many ways. For example, any suitable means for carrying out each of the functions described above may be employed to carry out the invention. In one embodiment, all or a portion of the elements of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium. It should also be noted, that although the above described principles have been applied in the context of image files, similar principles would also apply to the delivery of certain other data files. Examples of such data files include, but are not limited to, video and graphics files.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method of providing compression of image files, the method comprising:
modifying an input image by eliminating a predetermined number of bits from lower bit planes of the input image; and
encoding the modified image.

2. A method according to claim 1, wherein eliminating the predetermined number of bits of the input image comprises performing a bit plane shift of the predetermined number of bits.

3. A method of providing decompression of image files, the method comprising:
decoding an encoded image, the encoded image being modified by eliminating a predetermined number of bits from lower bit planes of an input image; and
reconstructing the decoded image by replacing the eliminated predetermined number of bits with replacement bits.

4. A method according to claim 3, further comprising selecting the replacement bits to have an optimal value to form a reconstructed image.

5. A method according to claim 4, wherein the optimal value is selected substantially as an average of maximum and minimum values of the eliminated predetermined number of bits.

6. A method according to claim 4, wherein the optimal value is selected as a random value.

7. A method according to claim 4, wherein reconstructing the decoded image further comprises performing a bitwise “or” operation between the reconstructed image and the replacement bits to produce an output image.

8. A method according to claim 3, wherein replacing the eliminated predetermined number of bits comprises performing a bit plane shift of the predetermined number of bits.

9. A method according to claim 3, wherein the predetermined number of bits is k and a value of replacement bits is c=2^{k-1}.

10. A method according to claim 2, wherein encoding the image further comprises inserting a marker to identify that the modified image has been bit plane shifted.

11. A computer program product for providing compression of image files, the computer program product comprising at least one computer-readable storage medium having computer-readable program code portions stored therein, the computer-readable program code portions comprising:
a first executable portion for modifying an input image by eliminating a predetermined number of bits from lower bit planes of the input image;
a second executable portion for encoding the modified image.

12. A computer program product according to claim 11, wherein the first executable portion eliminates the predetermined number of bits by performing a bit plane shift of the predetermined number of bits.

13. A computer program product according to claim 12, wherein the second executable portion further includes instructions for inserting a marker to identify that the modified image has been bit plane shifted.

14. A computer program product for providing decompression of image files, the computer program product comprising at least one computer-readable storage medium having computer-readable program code portions stored therein, the computer-readable program code portions comprising:
a first executable portion for decoding the encoded image, the encoded image being modified by eliminating a predetermined number of bits from lower bit planes of an input image; and
a second executable portion for reconstructing the decoded image by replacing the eliminated predetermined number of bits with replacement bits.

15. A computer program product according to claim 14, further comprising a third executable portion for selecting the replacement bits to have an optimal value to form a reconstructed image.

16. A computer program product according to claim 15, wherein the optimal value is selected substantially as an average of maximum and minimum values of the eliminated predetermined number of bits.

17. A computer program product according to claim 15, wherein the optimal value is selected as a random value.

18. A computer program product according to claim 15, wherein the second executable portion further includes instructions for performing a bitwise “or” operation between the reconstructed image and the replacement bits to produce an output image.

19. A computer program product according to claim 14, wherein replacing the eliminated predetermined number of bits comprises performing a bit plane shift of the predetermined number of bits.

20. A device for providing compression of image files, the device comprising:
a decoder capable of decoding the encoded image, the encoded image being modified by eliminating a predetermined number of bits from lower bit planes of an input image; and
a bit plane shift image reconstructor capable of reconstructing the decoded image by replacing the eliminated predetermined number of bits with replacement bits.

21. A device according to claim 20, wherein the bit plane shift image reconstructor is further capable of selecting the replacement bits to have an optimal value to form a reconstructed image.

22. A device according to claim 21, wherein the optimal value is selected substantially as an average of maximum and minimum values of the eliminated predetermined number of bits.

23. A device according to claim 21, wherein the optimal value is selected as a random value.

24. A device according to claim 21, wherein the bit plane shift image reconstructor is further capable of performing a bitwise “or” operation between the reconstructed image and the replacement bits to produce an output image.

25. A device according to claim 20, wherein the bit plane shift image reconstructor is further capable of performing a bit plane shift of the predetermined number of bits.

26. A mobile terminal for providing compression of image files, the mobile terminal comprising:
a bit plane shift image modifier capable of modifying an input image by eliminating a predetermined number of bits from lower bit planes of the input image; and
an encoder capable of encoding the modified image.

27. A mobile terminal according to claim 26, wherein the bit plane shift image modifier is further capable of performing a bit plane shift of the predetermined number of bits in order to eliminate the predetermined number of bits of the input image.

28. A mobile terminal according to claim 27, wherein the encoder is further capable of inserting a marker to identify that the modified image has been bit plane shifted.

29. A mobile terminal according to claim 26, wherein the encoder is a JPEG encoder.

30. A mobile terminal for providing decompression of image files, the mobile terminal comprising:
a decoder capable of decoding the encoded image; and
a bit plane shift image reconstructor capable of reconstructing the decoded image by replacing the eliminated predetermined number of bits with replacement bits.

31. A mobile terminal according to claim 30, wherein the bit plane shift image reconstructor is further capable of selecting the replacement bits to have an optimal value to form a reconstructed image.

32. A mobile terminal according to claim 31, wherein the optimal value is selected substantially as an average of maximum and minimum values of the eliminated predetermined number of bits.

33. A mobile terminal according to claim 31, wherein the optimal value is selected a random value.

34. A mobile terminal according to claim 31, wherein the bit plane shift image reconstructor is further capable of performing a bitwise “or” operation between the reconstructed image and the replacement bits to produce an output image.

35. A mobile terminal according to claim 30, wherein the bit plane shift image reconstructor is further capable of performing a bit plane shift of the predetermined number of bits.

36. A mobile terminal according to claim 30, wherein the decoder is a JPEG decoder.
